(19) United States
(12) Patent Application Publication
(10) Pub. No.: US 2025/0384464 A1
(43) Pub. Date: Dec. 18, 2025

(54) DEMOGRAPHIC DETERMINATION FROM GESTURES FOR AD TARGETING

(71) Applicant: Verve Group Inc., Carlsbad, CA (US)

(72) Inventors: Jeremias Shadbolt, Turku (FI); Juha Korhonen, Turku (FI); Tatu Salminen, Turku (FI); Jarmo Puolakanaho, Turku (FI)

(21) Appl. No.: 19/178,905

(22) Filed: Apr. 15, 2025

Related U.S. Application Data
(60) Provisional application No. 63/634,355, filed on Apr. 15, 2024.

(51) Int. Cl. G06Q 30/0251; G06F 3/01; G06Q 30/0204

(52) U.S. Cl. CPC G06Q 30/0269; G06F 3/017; G06Q 30/0204

(57) ABSTRACT

Systems and methods for obtaining anonymous demographics from gestures, where the method includes capturing information on one or more gestures performed by a user on a touchscreen of a device, along with motion data of the device. The gesture information and motion data in the form of deltas or deviations is provided to a machine learning (ML) model trained to analyze gestures and motion data and output predicted demographics. The predicted demographics from the ML model are then provided to an advertising provider, which send the device one or more ads targeted to the user based on the demographics. The device then displays the ads. Other embodiments are discussed herein.

### CROSS-REFERENCE TO RELATED APPLICATIONS

This application claims priority to U.S. Provisional Application No. 63/634,355, filed on 15 Apr. 2024, the contents of which are incorporated by this reference as if set forth fully herein.

### TECHNICAL FIELD

Disclosed embodiments are directed to ad targeting systems, and specifically to techniques for determining demographics of users for targeting ads based on captured gestures of users as they interact with touch devices.

### BACKGROUND

Smartphones, smartwatches, tablets, and other similar portable or mobile devices are ubiquitous, with many people routinely interacting with the Internet, applications, work, and friends and family via a mobile device. For some people, mobile devices may be the primary or only way in which they accomplish on-line tasks and communication. Modern mobile devices such as smartphones and tablets, and increasingly, laptops, are equipped with a touchscreen as a primary method of interaction, as well as various sensors, including motion sensors like accelerometers and gyroscopes. These motion sensors are widely applied for different purposes, for instance to detect the orientation of a phone and to determine whether the screen should be rotated from vertical to horizontal.

When equipped with a touchscreen as the primary method of interaction, touch-based actions like swiping, tapping and typing are frequently used methods of engaging with intelligent and/or mobile touchscreen equipped devices like smartphones, smartwatches, tablets, and increasingly, laptops. Touchscreen gestures are physical actions undertaken by a user to engage with specific controls within a mobile interface. Mobile gestures encompass a repertoire of touch-based actions executed on a touchscreen device, like a smartphone or tablet. Typically gestures are done using one or two fingers.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A to 1C illustrate various gestures that may be made on a device equipped with a touchscreen, according to various embodiments.

FIG. 2 illustrates a turning point angle quality that may be present in some gestures performed on a touchscreen, according to various embodiments.

FIG. 3 illustrates various aspects of a swipe gesture that may be performed on a device equipped with a touchscreen, according to various embodiments.

FIG. 4 illustrates possible device movements that may be captured by a motion sensor that may be equipped to a device with a touchscreen, according to various embodiments.

FIG. 5 depicts an example system for capturing and analyzing gestures performed on a touchscreen for determining user demographics and provide advertising based on the demographics, according to various embodiments.

FIG. 6 is a block diagram of a user device equipped with a touchscreen that may be used with the example system of FIG. 5, according to various embodiments.

FIG. 7 is a flowchart of an example method for capturing and analyzing gestures performed on a touchscreen device, and determining user demographics for providing advertising based on the demographics, according to various embodiments.

FIG. 8 is a block diagram of an example computer that can be used to implement some or all of the components of the disclosed systems and methods, according to various embodiments.

FIG. 9 is a block diagram of a computer-readable storage medium that can be used to implement some of the components of the system or methods disclosed herein, according to various embodiments.

### DETAILED DESCRIPTION

A user may interact with a touchscreen-equipped device using a variety of finger movements, known as gestures. A wide variety of gestures may be supported by a given device, depending on the specifics of its implementation, such as the touchscreen's sensing capabilities and operating system support for different types of gestures. Some non-limiting examples may include swipes, pinches, zooms, taps, and rotates. Gestures may be performed with one or multiple fingers. The functions triggered by a given gesture may depend upon the configuration of a given device's operating system and/or a given application running on the device.

Because each user of a touchscreen device is a unique individual with unique biometrics, how a given person performs a gesture varies slightly from person to person. Moreover, characteristics of a given user's gestures are typically consistent or similar with the gestures performed by other individuals who share a common demographic, e.g., age and gender. For example, a swipe, sometimes called flick or fling, is a special gesture usually done with one finger. A user typically performs a swipe by sliding one of their fingertips, typically the thumb or index finger, across the touchscreen while maintaining contact with the screen. As a touchscreen device typically samples input from the touchscreen at regular intervals, a swipe forms a series of time-stamped points, each of which may be identified at a physical x, y location on the touchscreen, that collectively trace the path of the gesture as it travels across the screen.

The spacing and positioning of each point relative to their respective time stamps can vary depending on the demographic of the user making the gesture. For example, a female with relatively small hands may create a swipe path with closer spaced time-stamped points compared with a male with relatively large hands, and this closer spacing may be used to distinguish whether a male or a female is operating a particular device. This will be discussed in greater detail below.

In addition to specific demographics, different individuals produce different kinds of swipes, as well as other types of gestures. The uniqueness and distinctiveness of how a user performs a given gesture makes it possible to use gestures to identify a certain person. Additionally, these distinctive differences can differentiate and follow multiple users who use the same device, and even allow cross-device tracking, i.e. recognize the same user across multiple devices.

As mentioned above and continuing to use swipes as one example, there are differences between male and female populations in several swipe features. However, these differences can vary depending on the nature of a particular swipe. Specifically, in the down-to-up direction the differences include: Width, Area and Angle Start to End. In the left-to-right direction: Total Time, Average speed, Average Arc Distance and Max arc Distance. Swipes in the up-to-down direction only showed significant differences in the Width feature. Swipes in the right-to-left direction failed to show any significant differences, at least insofar as distinguishing between male and female users.

Age is another possible demographic which can be determined from gesture characteristics. Children have smaller fingers which result in a smaller touch area on the screen. Children tend to swipe faster than adults, and children produce shorter and less curvy swipes. Distance offset and tap time are enough to classify whether the user is a small child or an adult.

Some gestures are more suitable for determining certain types of demographics compared to others. For example, scroll down is another gesture that may allow good classification between children and adults. Other gestures usable for age classification (in contrast to gender) include pinch-to-zoom, swipe right-to-left, and swipe left-to-right. Gesture characteristics based on the dimension, area and the pressure of the gesture can be informative for age distinction. Other types of gestures may be suitable for determining other demographics and, in some cases, a given gesture may be suitable for distinguishing multiple types of demographics.

Online and in-app advertising, as with any advertising, is preferably targeted based on a given user's specific demographic characteristics to maximize impact and return on investment. Further, as users increasingly have and/or use multiple computing devices (mobile or otherwise), tracking a given user to provide targeted advertising across multiple devices is desirable. However, privacy is also a serious concern for many users of mobile devices, with many users unsettled at the thought of being specifically tracked. Furthermore, in various jurisdictions, the use of personal data specific to a user, such as demographic information, location, app usage, website history, etc., may be subject to a variety of different regulatory schemes that control the extent to which a user's personal information may be disseminated and/or used, including for tracking purposes. In some situations, a user may not desire and/or regulations may not permit any information to be released outside of a user's direct control (at least without a user's direct or explicit consent) that could allow a given user to be specifically identified or otherwise tracked by an advertiser or another potentially malicious actor. In such situations, only generic demographic information may be permitted to be shared with advertisers, which can limit the degree to which advertising can be specifically tailored to a given user. Historically, this information can be difficult to ascertain without inadvertently gaining access to potentially sensitive private or personal information.

In still other scenarios, content may be intended only for adults and/or laws or regulations may severely restrict the types of data that can be collected on minors. Alternatively or additionally, some applications may present content that is unsuitable for minors. While some applications may inquire about the age of a user, this is no block for a minor who understands to answer the age question to indicate they are not a minor. In such situations, it would be beneficial to determine whether a user is, in fact, a minor using information that is not easily faked. Capture and analysis of user gestures can provide a way of verifying a user's age, or at least imposing additional checks or validation to help ensure that a minor is not using a device to access inappropriate material and/or is tracked in contravention to law.

Disclosed embodiments include methods and systems for using a user's gestures to determine a demographic profile for the user. This demographic profile may then be used to select and provide targeted advertising to the user. As gestures are employed to make demographic classifications, demographic information can be determined without the need to access any sensitive private or personal information on a given device. As a result, a user can be provided with targeted advertising while keeping any sensitive private or personal information under the control of the user, on the user's device(s). In some such embodiments, no personal information may need to be accessed. Furthermore, employing demographics can, in some embodiments, allow a user to be uniquely identified and tracked across devices without ever determining any information that could allow the user's identity or other personal information to be specifically determined or accessed. Other embodiments will be discussed herein.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

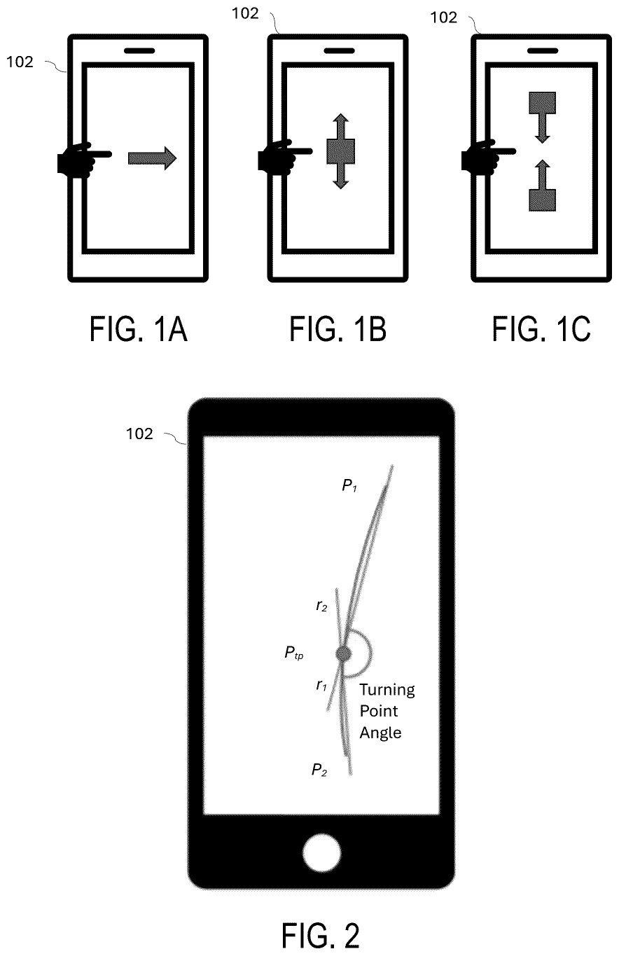

FIGS. 1A to 1C illustrate several different possible types of gestures that may be performed by a user of a mobile device 102, such as a smartphone or tablet. FIG. 1A illustrates a swipe from left to right, where a user makes contact with the screen with their finger while keeping the finger in motion until lifting off the screen. Depending on a given device and/or application being used on the device, swipes may page through information or objects, such as flipping through a photo library, scrolling through a webpage or other screen, interacting with a game, controlling an operating system, etc. Although FIG. 1A only illustrates a left-to-right swipe, a person skilled in the art will readily understand that swipes may be from a variety of directions, such as right-to-left, top-to-bottom, bottom-to-top, diagonally, or in various patterns. Multiple swipes may be connected together to form more intricate patterns, such as entering a character or shape.

Swipes may be performed in a variety of different fashions. Some possible examples include a moving swipe, where the user touches the screen, drags, then lifts, all while the finger is in motion; a flick, where the user initially touches the screen before moving, starts motion, then lifts while the finger is still in motion; or a scroll, where the user touches the screen, starts motion, drags the finger across the screen, then stops before lifting. In some instances, a user may perform a swipe motion with multiple fingers, e.g. swiping with two, three, or more fingers at once. The number of fingers may be recognized and used to distinguish between single finger or different numbers of fingers for a given gesture, which may in turn result in a given application and/or device performing different actions.

FIG. 1B illustrates another type of possible gesture, the zoom. In this gesture a user typically places two or more fingers on the screen, and pulls the fingers away from each other. In the illustration of FIG. 1B, a user would place two fingers on the screen while the fingers are proximate or touching each other, then move the fingers away from each other while dragging on the screen. A zoom gesture can be thought of as performing two scroll gestures in opposite directions, while starting from roughly the same point on the touchscreen. Zoom gestures, as the name implies, are often used to zoom in on content on the touchscreen. Other gestures may utilize more than two fingers, such as placing four fingers on a touchpad and flicking out, which can reveal a desktop or move application windows on some systems.

FIG. 1C illustrates yet another type of gesture, the pinch. The pinch can be thought of as the opposite of the zoom, where two or more fingers are spread apart before being placed on the touchscreen, then drawn together. As with a zoom gesture, a pinch can be thought of as two scroll gestures that start apart, but end in roughly the same point. In keeping with a pinch being the opposite of the zoom, a pinch may be used to zoom out on content, such as restoring it to its original scale after a zoom gesture. As with a zoom, a pinch may be performed using more than two fingers. For example, pinching in using four fingers may invoke an application tray on some systems.

As mentioned above, the way that some swipes are performed may vary depending on a given user. FIG. 2 illustrates the concept of a turning point angle. The turning point angle is essentially an inflection point that some users naturally create while performing a swipe gesture. For example, many users may hold a device in one hand, and use the thumb of the holding hand to perform a swipe. When the swipe is performed, due to the geometry of a human hand, the thumb may rise (in a bottom-to-top or down-to-up swipe) in one direction, then curve off to complete the motion in a different direction. The point or area where the thumb significantly changes direction defines a turning point, and the turning point angle is the angle between the general direction of the initial rise and the direction of the finishing motion. A similar pattern may be formed when the thumb performs a top-to-bottom or up-to-down swipe.

FIG. 2 illustrates these various points. The curved path illustrated as extending between a point P₁ and a point P₂ is the path taken by a user's finger. It will be appreciated that people generally make swipe gestures in a continuous motion, rather than two discreet straight segments. However, the curved path approximates two segments, a first segment between point P₁ and point Pₜₚ, and a second segment between point Pₜₚ and point P₂. The point Pₜₚ is the turning point, and the turning point angle is the obtuse angle defined between the first segment and the second segment. For purposes of demographic distinction, males (who as a general rule have bigger hands and longer fingers over females) perform swipe gestures with straighter, faster, and longer swipes. Thus, the turning point angle of a swipe performed by a male is typically more obtuse (closer to 180 degrees) than the turning point angle of a swipe performed by a female, which is typically more acute (closer to 90 degrees). Determining the turning point angle from captured touchscreen data is one possible data point that could allow determining a gender demographic of a user.

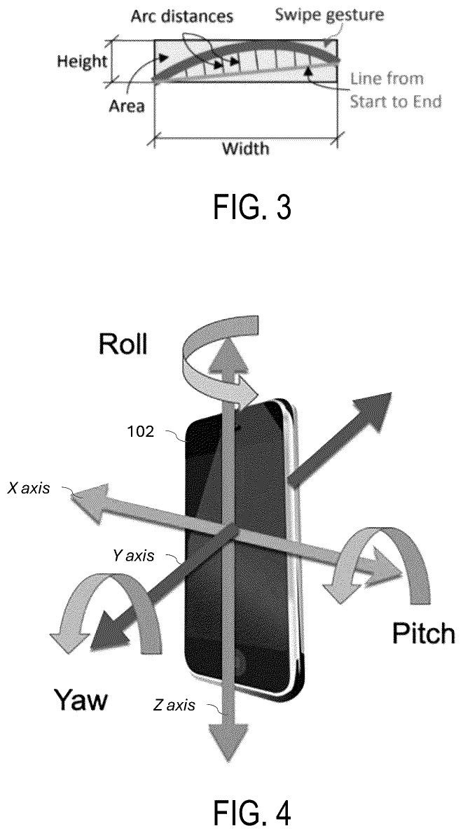

FIG. 3 illustrates various aspects of a swipe that can be captured and measured from the touchscreen of a device, such as device 102. A swipe can be analyzed for several different aspects, including height, width, and area. In the illustrated example, the curve of the swipe travels away from the starting point in both a height and width direction. The width of the swipe is essentially the length along a single width axis the swipe travels from its starting point to the ending point. The height of the swipe, as shown, is essentially the distance the swipe deviates between the location of its starting point and the furthest it travels away from the starting point along a height axis that is orthogonal (perpendicular) to the width axis, even though the swipe travels back towards the starting point in a height direction at the ending point. A series of arc distances, defined as the deviation of the swipe path compared to a straight line drawn between the starting and ending points, illustrate points at which the travel of the swipe may be sampled by the touchscreen (or associated device 102) while a user performs the swipe gesture. The distance between each of these sample points can be analyzed to determine the speed of a given swipe. If the sample points are relatively close, it indicates a slow swipe, while greater distances indicate a relatively fast swipe. It should further be understood that the width and height axes, although appearing as horizontal and vertical in FIG. 2, respectively, can be in any orientation, depending upon the direction of a given swipe gesture (e.g. up-to-down, down-to-up, left-to-right as illustrated, right-to-left, diagonally, etc.).

Further, as seen in FIG. 3, an area of the swipe may be ascertained. The area can be defined by the width times the height, to determine the area of the screen over which the swipe is performed. Also, the touchscreen may be able to measure an area in which the user presses their finger on the touchscreen. A person's finger is blunt, so that a user does not touch a single point on the screen, but rather an area. The amount of area a given touch may consume depends on various factors such as the size of a person's finger and how hard the press on the touchscreen. The harder a user presses, the greater an area is covered by the press. This area, as will be understood, can continue over the distance over the screen traversed by a given swipe gesture, and may vary over the path, e.g. a user making a moving swipe may have a relatively small contact area at the point of initial screen contact, which may increase in the middle of the path, and decrease again as the end point of contact is reached. Thus, a device 102, in embodiments, may be able to derive differences in pressure that a user may apply to perform a gesture, particularly when combined with motion data, which will be discussed below with respect to FIG. 4.

These differences in height, width, area, contact size/pressure, and speed can all be analyzed and correlated to a particular demographic. Men, for example, may have larger contact areas, longer widths, but smaller heights (straighter swipes/greater turning point angles), and may be generally faster in performing gestures. Women, for example, may have smaller contact areas, shorter widths, and larger heights, and may generally be slower. Children may have even smaller contact areas, generally faster gestures than either male or female adults, and shorter widths.

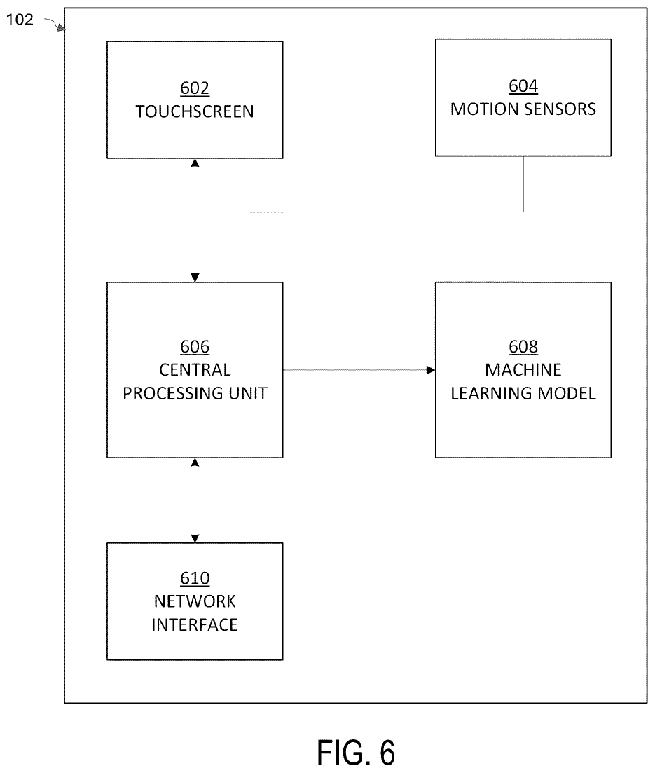

FIG. 4 illustrates the capture of motion data by user device 102 while it is being operated by a user when performing a gesture on the touchscreen. Motion data may be captured by way of one or more motion sensors equipped to the user device 102, as will be discussed below with respect to FIG. 6. Camera motions may include both angular rotation as well as linear motion. Angular rotation is rotation about the X, Y, and Z axes, such as pitch (X axis), yaw (Y axis), and roll (Z axis), and may be measured by one or more gyroscopes. A device 102 that is only moved with angular rotation would remain in a fixed position in space, but would be rotated along the various axes. Linear motion is a change in spatial position, such as translations along the X, Y, and/or Z axes, and may be measured by one or more accelerometers.

With respect to demographics, the amount of force that a user applies to a device 102 while making various gestures may vary depending on the age and gender of the user. For example, men typically apply greater pressure, and as a result, the device may move (both rotationally and laterally) to a greater extent-nearly double-during making a gesture as compared to a woman user. A child may move the device further still but with different movement patterns, depending on the child's age and how much they are able to hold the device steady in operation. Still further, motion data may be analyzed to determine which particular finger or fingers are being used by a user to interact with the device 102. For example, the greater movement by a male user compared to a female can be the result of men tending to operate a device with a single hand, versus women being more likely to operate a device with two hands.

The foregoing has focused on the swipe gesture, rather than including pinch and zoom gestures. Referring back to FIGS. 1A to 1C, it should be understood that various gestures can essentially be broken down into a series of swipes, which may be performed simultaneously, such as in the case of a pinch or zoom, or may be performed serially, such as in the case of forming a pattern. As each of these gestures may be formed from relatively simple swipes, each constituent swipe can be analyzed according to the aspects described above with respect to FIGS. 2 and 3 to form a unique analysis of gestures such as pinches and zooms. Also, gestures such as taps, where the finger is not moved (or moved only slightly) on the screen, can be considered a special form of swipe where the start and end points are essentially the same, with only the area of the touch (see FIG. 3 and the accompanying description above) being considered.

It should be understood that determining relatively accurate specific demographics for a user may involve the analysis of the characteristics of multiple different gestures, of different types, along with device motion data. Such data, when taken in aggregate, can form something of a unique “fingerprint” of a given user that allows the user to be targeted based on their ascertained demographics as well as tracked across devices. As gesture data does not otherwise reveal anything specific about the user (other than distinguishing between users), a user's privacy is maintained while demographic specifics for the user can be determined for targeting advertisements.

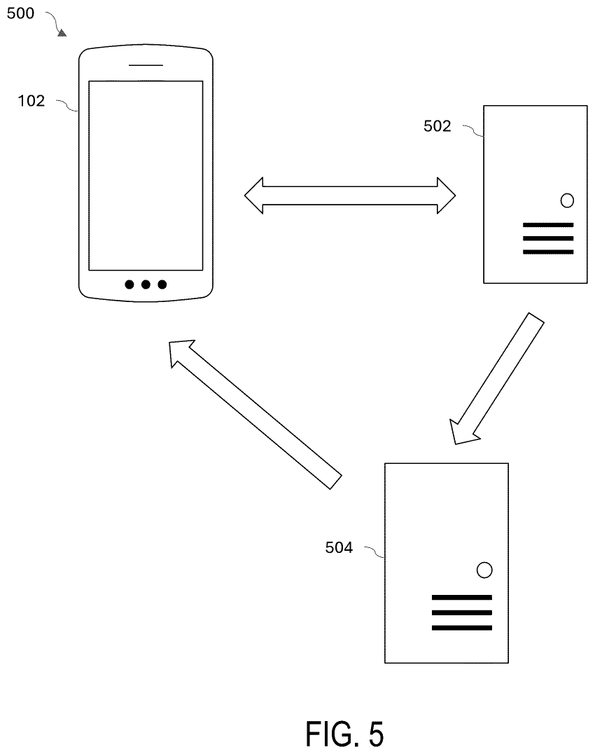

FIG. 5 depicts a system 500 for providing targeted advertising to a user of a user device 102 based on demographic data derived from gesture analysis. Example system 500 includes a user device 102, a server 502, and an advertising (ad) provider 504. Some embodiments may add, substitute, or subtract components as determined by the needs of a given implementation.

In the example system 500, user device 102 is in two-way communication with the server 502. Server 502 may provide one or more machine learning (ML) models to the user device 102 which are configured to analyze captured gestures and associated motion information to determine user demographics. The one or more ML models may be trained to target determination of specific demographics depending on the needs of a given embodiment. In some embodiments, the ML model or models is/are executed on the user device 102, so that all gesture and motion information remains local to the device, and only de-identified demographic information is transmitted from the device. In other embodiments the server 502 may handle some or all analysis of captured gesture and motion information to determine demographics, if permitted by regulations and/or if the user device 102 lacks the necessary processing power to execute the ML model or models. In such embodiments, the user device 102 may transmit gesture and motion information to the server 502, which in turn determines, using the ML model or models, the desired demographics of the user.

As can be seen in FIG. 5, the user device 102 is in two-way communication with server 502, for transmission of ML models, gesture information, motion information, and/or calculated demographics, according to various embodiments. The server 502 in turn is in communication with an ad provider 504, such as a server or cloud service of the ad provider 504. The ad provider 504 accepts the anonymized demographics from the server 502 and uses them to select one or more ads that are targeted to a user fitting the anonymized demographics. In some instances, the anonymized demographics may be sufficiently detailed to identify a specific user (a demographic fingerprint), in which case this fingerprint may be used to track a given user across various devices, albeit without having any knowledge of the user's identity. The selected ads, as illustrated in FIG. 5, may be transmitted to the user device 102 for display to the user. While the example embodiment depicted in FIG. 5 shows the server 502 providing the demographics to the ad provider 504, in some embodiments the user device 102 may directly transmit the demographics to the ad provider 504, rather than relying on the server 502 to relay them to the ad provider 504.

When the server 502 provides an ML model to the user device 102, the ML model may be pre-trained by the server 502, so that the user device 102 need only pass captured demographic data to the ML model for processing to output demographics. The ML model, in some embodiments, may be some form of an artificial neural network.

FIG. 6 is a block diagram of the example user device 102 discussed herein, according to various embodiments. The user device 102 may include a touchscreen 602 and motion sensors 604, which may be in communication with one or more central processing units (CPUs) 606. The central processing unit 606 may further be in communication with and execute a machine learning model 608 and may communicate with devices external to the user device 102 via one or more network interfaces 610.

The touchscreen 602 may be any touchscreen panel that is suitable for use on a mobile device, as is now known or later may be developed. The touchscreen 602 may combine both touch capabilities with a display, such as is found on smartphones and tablets. In other embodiments, the touchscreen 602 may be implemented using a separate touch device, such as a trackpad, that is separate from the device's display. The touchscreen 602 may register multiple simultaneous touches (e.g., multi-point touch), and in some implementations may be capable of measuring the force of a touch. Further, the touchscreen 602 may be implemented using any suitable technology now known or later developed, such as capacitive touch sensing, resistive touch sensing, optical touch sensing (e.g. using a matrix of LEDs and photodetectors), visual touch sensing (e.g. using a camera or other optical sensor), or a combination of any of the foregoing. The touchscreen 602 may sample the panel for inputs on a regular basis, such as with a clock or refresh rate, or such sampling may be accomplished by another component of device 102, such as the CPU 606 or another suitable component or components.

As mentioned above, the touchscreen 602 may also act as a display device for the user device 102. In this capacity, touchscreen 602 may display any ads received from an ad provider (such as described above with respect to FIG. 5) in response to obtaining demographic information from captured gestures and motion data. In such a case, the touchscreen 602 may also be equipped with or otherwise in communication with one or more video driver circuits. These circuits may be separate components, such as a northbridge or discrete GPU, or be integrated into another component of user device 102, such as the CPU 606.

Motion sensors 604 may include one or more gyroscopes and/or one or more accelerometers, as mentioned above with respect to FIG. 4. There may be one gyroscope and accelerometer for each axis X, Y, and Z, so that the motion sensors 604 provide six degrees of motion sensing. Motion sensors 604 may be implemented using MEMS (micro-electronic mechanical sensors) technology, or another suitable technology now known or later developed.

CPU 606, in embodiments, may be a general purpose CPU, and may have a single or multiple processing cores. In some embodiments, CPU 606 may comprise multiple physical CPU packages, such as on a multi-processor device. CPU 606 may, in embodiments, be implemented using a separate chipset, such as northbridge and southbridge chips, separate memory controllers, separate interrupt controllers, and the like. In other embodiments, CPU 606 may be a System on a Chip (SoC), with northbridge/southbridge, graphics processing units (GPUs), memory controllers, and even memory chips, located on a single package. In still other embodiments of a user device 102, CPU 606 may be implemented using application-specific circuitry (e.g. an ASIC), a field-programmable gate array (FPGA), or other specialized circuitry or microchips. In user device 102, the CPU 606 may coordinate receiving data from the touchscreen 602 and motion sensors 604, and providing them to machine learning model 608. In some embodiments, the CPU 606 may be equipped with hardware specially designed to execute a neural network, such as one or more neural processing units.

Machine learning model 608 may be any suitable machine learning (ML) system configured to analyze captured gestures and motion information, and output demographic information on the basis of the gestures and motion information. The machine learning model 608 may be implemented using any suitable ML technology, such as one or more artificial neural networks (ANNs). Where an ANN is employed, the ANN may be pre-trained on a training set of gesture and motion data to return accurate demographics. As mentioned above with respect to FIG. 5, the machine learning model 608 may be obtained from a remote server, such as via the network interface 610. When obtained from a remote server, the ANN may be pre-trained by the remote server. In other embodiments, the user device 102 may train the ANN prior to use (such as with a training set that may be obtained from the remote server), or may receive a partially-trained model from the remote server, and may finalize training using any data unique to the user device 102, as may be appropriate for a given implementation. The machine learning model 608 may reside in volatile or non-volatile storage equipped to the user device 102, such as memory that is part of CPU 606 when implemented as a SoC, and/or via flash storage (not shown).

Demographic results obtained from the machine learning model 608 maybe output via the network interface 610. The network interface 610 may be any suitable network interface, including one or more WiFi modems, one or more ethernet transceiver (for a wired network), one or more cellular radios (for 2G/3G/4G/5G networks), and/or a combination of any of the foregoing. The network interface 610 may allow the user device 102 to communicate with the remote server and/or an advertising provider, which may send ads to the user device 102 via the network interface 610 in response to receiving demographic information.

It should be understood that the example user device 102 depicted in FIG. 6 is only one possible implementation. User device 102 may have more, fewer, or different components, and the components may communicate with one another in a different fashion or via different communication paths than as depicted in FIG. 6, depending on the needs of a given implementation.

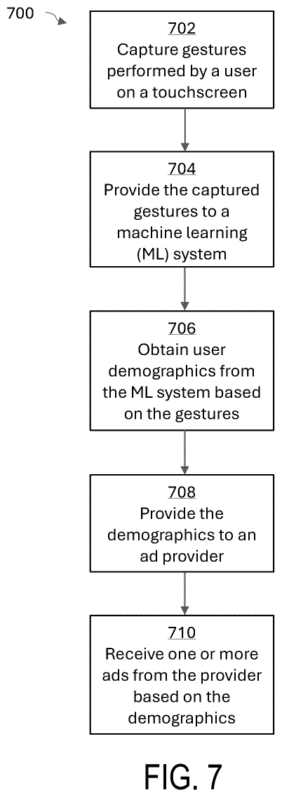

FIG. 7 is a flowchart of the operations for an example method 700 that may be carried out on a device 102 (FIG. 6), as part of a system 500 (FIG. 5). The reader is directed to the foregoing descriptions for more detailed explanation of some of these aspects. The operations of method 700 may be carried out in whole or in part, or in the depicted order or out of order. Depending on the needs of a specific implementation, some operations may be omitted or altered, while other operations may be added, without departing from the spirit of the invention. Some aspects of method 700 may be carried out by other devices, such as a remote server and/or an advertising provider.

In operation 702, gestures performed by a user on a user device touchscreen are captured. As described above, the touchscreen and/or driving circuitry or CPU may sample the touchscreen at regular intervals, such as a refresh rate, to capture a stream of raw data. Software executing on the user device and/or hardware may monitor for when a user makes contact with the touchscreen to begin capture of gesture data, and stop capture when the user breaks contact with the touchscreen. Further, when a touch is detected, motion data from a motion sensor (such as motion sensor 604, FIG. 6) may be simultaneously captured so that the gestures have associated motion data.

Table 1 lists sixteen (16) characteristics that are captured and/or associated with various gestures as they are performed by a user, in various embodiments. These characteristics may be analyzed by a trained ML system to determine demographic information:

TABLE 1

| Name | Description |
|---|---|
| SessionID | May be used in a custom mobile application to |
| | differentiate users from each other. |
| Age | Participants' age |
| Gender | Participants' gender identity |
| GestureType | Type of gesture (SU, SD, L2R, R2L) |
| TimeStartMS | Timestamp gesture started calculated in ms starting |
| | from Jan. 1, 1970. |
| TimeEndMS | Timestamp gesture ended calculated in ms starting |
| | from Jan. 1, 1970. |
| SwipeTickRelativeTimeMS | A 10 ms interval where data points were gathered |
| | from during the gesture |
| SwipeTickXCoordinate | X coordinate of the location of the finger performing |
| | the gesture at SwipeTickRelativeTimeMSi |
| SwipeTickYCoordinate | Y coordinate of the location of the finger performing |
| | the gesture at SwipeTickRelativeTimeMSi |
| SwipeTickThickness | Area covered by finger performing the gesture at |
| | SwipeTickRelativeTimeMSi |
| SwipeTickVelocity | Velocity of the gesture at |
| | SwipeTickRelativeTimeMSi |
| SwipeXStart | X coordinate of where the gesture started |
| SwipeYStart | Y coordinate of where the gesture started |
| SwipeXEnd | X coordinate of where the gesture ended |
| SwipeYEnd | Y coordinate of where the gesture ended |
| SwipeDuration | Duration in ms |

As will be understood, some of these data points must be captured from alternative sources and/or directly entered by a user, such as when data is used to train the ML model. When the ML model is used to analyze gesture and motion data, some of these data points, such as age and gender, are the intended output from the trained ML model. In addition to the foregoing characteristics, as mentioned above, motion data of the user device may also be captured. This motion data may be captured contemporaneously with capture of the gesture information, such as the characteristics listed in Table 1. Table 2 lists some aspects of motion data that may be captured:

TABLE 2

| Name | Description |
|---|---|
| SwipeTickRoll | Position of the device in Roll-axis at |
| | SwipeTickRelativeTimeMSi |
| SwipeTickYaw | Position of the device in Yaw-axis at |
| | SwipeTickRelativeTimeMSi |
| SwipeTickPitch | Position of the device in Pitch-axis at |
| | at SwipeTickRelativeTimeMSi |

The captured motion data may, as discussed above, also include parameters for lateral motion/translation of the device, measured using one or more accelerometers.

In some embodiments, the user device may keep (or send to a remote server) an optimized history of user gestures over a rolling time window. For example, the user device may store the last n-number (e.g., 20, 30, 100, etc.) of gestures performed, or may store all gestures performed over some past time period (e.g. last minute, 30 seconds, hour, second, fraction of a second, etc.). They may be optimized, e.g. gestures may be de-duplicated, or only unique gestures performed in the rolling window may be kept. In embodiments, optimization may include removal of any data that isn't relevant to the ML system and its analysis of the gesture data, e.g., sensor data that is determined to be unrelated to gestures, such as motion data resulting from device movements that are not connected to a given gesture, etc. Optimization may also be employed to reduce the overall impact of the gesture data on the ML system and/or other systems involved in its handling and processing, such as reducing data size, optimizing layouts, etc., to minimize impact on necessary storage space, I/O bandwidth, processor load, etc.

In operation 704, the captured gestures and motion data are provided to a machine learning (ML) system, such as an ANN. The gestures and/or motion data may be provided to the ML system in the form of deviations, rather than absolute data. In particular, motion data may be provided as delta changes or deviations in conjunction with the gesture data, such as gesture start time and position, gesture stop time and position, and various intermediate positions at sampled intervals. By providing the motion data as deltas or deviations, the impacts of absolute device position can be avoided.

For example, if a user holds a device upside down, such as when lying in bed, absolute motion data may be recorded as unusual values, which may cause the ML model to output inaccurate results. This may be due to the nature of training sets for the ML model. The absolute values of motion data may vary wildly depending on the position of a user device. However, the training data may be largely based on users holding devices in a relatively conventional upright orientation. The set may lack significant data points where a device is held in an unusual orientation, such as when the user is lying down or reclining. Using deviations or deltas between motion points, rather than absolute values, can avoid having to provide a comprehensive data set that covers all possible absolute values, resulting in a smaller training set that requires less time and resources in training the ML model. The deviations or deltas can assume a common starting point for motion (e.g. zero rotation and zero movement), and use the deltas or deviations to track the relative movement of the user device. Thus, a training set that just uses devices in a normal upright orientation, if the movement data for training is delta or variations, will be able to provide a trained ML model that supplies accurate results of demographics regardless of the position in which a user uses the device.

In operation 706, the ML model analyzes the gestures and motion data, and returns demographic information about the user. Depending on how the ML model is implemented and trained, it may require a certain minimum number of gestures and associated motion data to return accurate demographics. The specific demographics returned by the ML model will depend upon the specific model and how the model was trained, according to the needs of a given implementation. For example, some ML models may be trained to determine a user's gender and age. Other ML models may be trained to estimate whether a user is a minor, so as to disable access to information and/or applications that are inappropriate for minors. In still other implementations, the device may employ multiple ML models, each trained and/or optimized to determine a different demographic. As mentioned above, in some embodiments the ML model may be designed to generate a fingerprint of the user based on the gesture and motion data, which can be used to follow the user from device to device or identify if a user of a particular device has previously used other devices.

In operation 708, the predicted demographics are sent to an advertising provider. The demographics may be sent either via a remote server, or via the user device directly to the advertising provider. Importantly, in embodiments no raw data or identifiable information is sent to the advertising provider, but only anonymized demographic data.

In operation 710, the advertising provider sends to the user device one or more ads, which are targeted to the user based on the demographics resulting from the ML analysis of the gesture and motion data. As mentioned above, in some embodiments the ML analysis may provide sufficient information to create a fingerprint or other information to identify a particular user. This identification may be done by the advertising provider with the fingerprint being provided as part of the demographics.

Following receipt of the ads, the user device may display the ads to the user on the touchscreen or other display device connected to the user device.

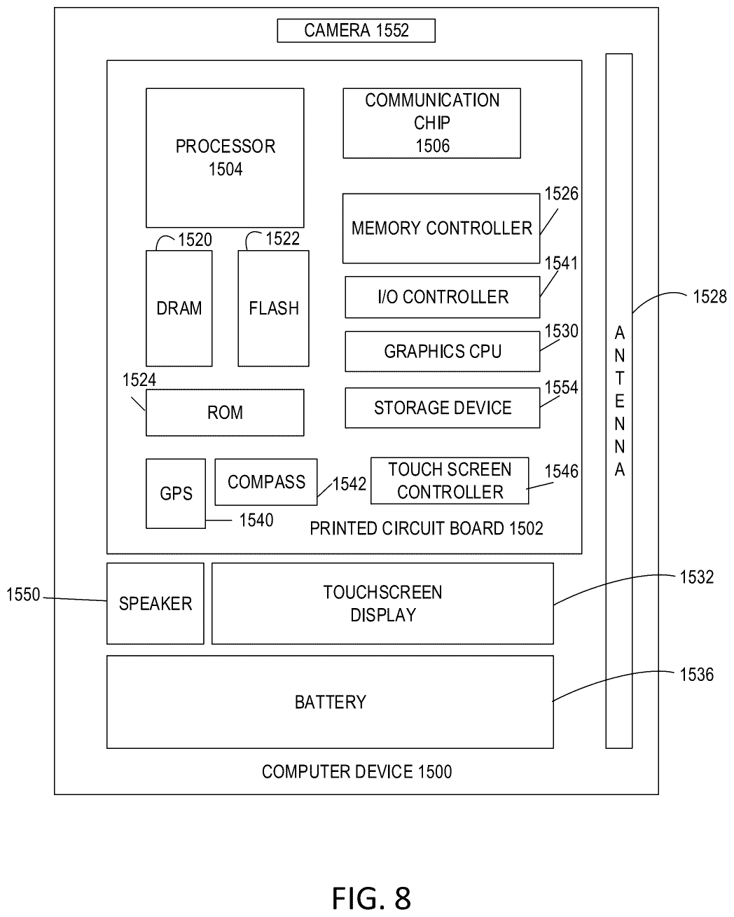

FIG. 8 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of system 500, device 102, or method 700 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

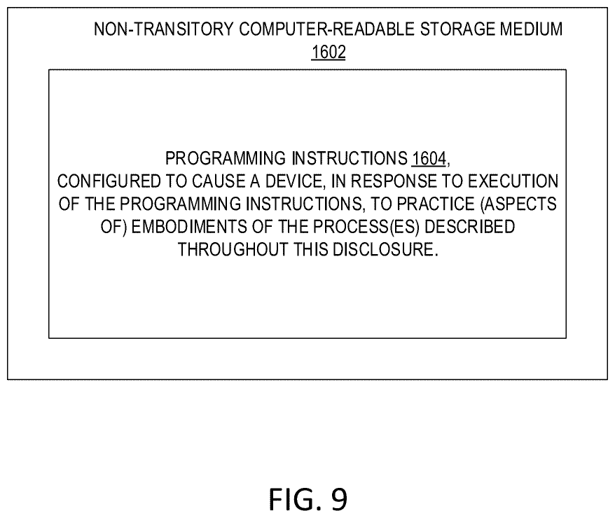

FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) system 500 or method 700 described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
capturing, by a user device comprising a touchscreen, one or more gestures performed by a user on the touchscreen;
providing, by the user device, the one or more captured gestures to a machine learning (ML) system;
obtaining, from the ML system, one or more demographics of the user based on the captured gestures, the one or more demographics incapable of being used to personally identify the user;
providing, by the user device, the one or more demographics to an ad provider; and
receiving, at the user device, one or more ads from the ad provider, the one or more ads targeted to the user based on the one or more demographics.

2. The method according to claim 1, further comprising maintaining, on the user device, an optimized history of user gestures over a rolling time window.

3. The method according to claim 1, wherein the one or more gestures comprise at least one of: a swipe up, a swipe down, a swipe from left to right, a swipe from right to left, a pinch, or a zoom.

4. The method according to claim 1, wherein capturing the one or more gestures performed by the user on the touchscreen comprises capturing one or more of: a gesture start time, a gesture stop time, a gesture start coordinate on the touchscreen, a gesture stop coordinate on the touchscreen, or a gesture thickness.

5. The method according to claim 4, wherein capturing the one or more gestures performed by the user on the touchscreen further comprises capturing motion data of the user device while a gesture of the one or more gestures is being performed.

6. The method according to claim 5, wherein capturing motion data of the user device comprises capturing data from one or more of an accelerometer or a gyroscope that are part of the user device.

7. The method according to claim 5, further comprising determining, from the motion data, a standard deviation for the captured motion data, wherein determining a standard deviation for the captured motion data comprises:
obtaining initial motion data of the user device at the start of or just prior to the user commencing a gesture;
obtaining ending motion data of the user device at the end of or just after the user ending the gesture; and
calculating, from the initial motion data and ending motion data, a deviation of a position of the user device at the end of the gesture from the start of the gesture.

8. The method according to claim 1, wherein the ML system comprises an artificial neural network (ANN).

9. The method according to claim 8, wherein the ANN is a pre-trained static model that is executed locally by the user device.

10. A non-transitory computer readable medium (CRM) comprising instructions that, when executed by an apparatus, cause the apparatus to:
capture one or more gestures performed by a user on a touchscreen;
maintain an optimized history of user gestures over a rolling time window;
provide the one or more captured gestures to a machine learning (ML) system;
obtain, from the ML system, one or more demographics of the user based on the captured gestures, the one or more demographics incapable of being used to personally identify the user;
provide the one or more demographics to a provider of advertisements (ads); and
receive one or more ads from the provider, the one or more ads targeted to the user based on the one or more demographics.

11. The CRM according to claim 10, wherein the one or more gestures comprise at least one of: a swipe up, a swipe down, a swipe from left to right, a swipe from right to left, a pinch, or a zoom.

12. The CRM according to claim 10, wherein the instructions, when executed by the apparatus, further cause the apparatus to capture the one or more gestures performed by the user on the touchscreen by capturing one or more of: a gesture start time, a gesture stop time, a gesture start coordinate on the touchscreen, a gesture stop coordinate on the touchscreen, or a gesture thickness.

13. The CRM according to claim 12, wherein the instructions, when executed by the apparatus, further cause the apparatus to capture the one or more gestures performed by the user on the touchscreen further by capturing motion data of the user device while a gesture of the one or more gestures is being performed.

14. The CRM according to claim 13, wherein the motion data of the user device comprises data from one or more of an accelerometer or a gyroscope that are part of the user device.

15. The CRM according to claim 14, wherein the instructions, when executed by the apparatus, further cause the apparatus to determine, from the motion data, a standard deviation for the captured motion data, and wherein the instructions to determine a standard deviation for the captured motion data cause the apparatus to:
obtain initial motion data of the user device at the start of or just prior to the user commencing a gesture;
obtain ending motion data of the user device at the end of or just after the user ending the gesture; and
calculate, from the initial motion data and ending motion data, a deviation of a position of the user device at the end of the gesture from the start of the gesture.

16. The CRM according to claim 10, wherein the ML system comprises an artificial neural network (ANN), wherein the ANN is a pre-trained static model that is executed locally by the apparatus.

17. A system, comprising:
a user device, comprising:
a touchscreen;
a storage device; and
one or more processors in data communication with the storage device and the touchscreen;
a remote server in data communication with the user device; and
an advertisement providing system in data communication with the user device;
wherein the storage device stores instructions that, when executed by the one or more processors, cause the user device to:
capture one or more gestures performed by a user on a touchscreen, wherein the one or more gestures comprise at least one of: a swipe up, a swipe down, a swipe from left to right, a swipe from right to left, a pinch, or a zoom;
maintain an optimized history of user gestures over a rolling time window;
provide the one or more captured gestures to a machine learning (ML) system;
obtain, from the ML system, one or more demographics of the user based on the captured gestures, the one or more demographics incapable of being used to personally identify the user;
provide the one or more demographics to the advertisement providing system; and
receive one or more advertisements from the advertisement providing system, the one or more advertisements targeted to the user based on the one or more demographics.

18. The system according to claim 17, wherein the instructions, when executed by the one or more processors, further cause the user device to capture:
the one or more gestures performed by the user on the touchscreen by capturing one or more of: a gesture start time, a gesture stop time, a gesture start coordinate on the touchscreen, a gesture stop coordinate on the touchscreen, or a gesture thickness; and
motion data of the user device while a gesture of the one or more gestures is being performed,
wherein the motion data of the user device comprises data from one or more of an accelerometer or a gyroscope that are part of the user device.

19. The system according to claim 17, wherein the instructions, when executed by the one or more processors, further cause the user device to determine, from the motion data, a standard deviation for the captured motion data, and wherein the instructions to determine a standard deviation for the captured motion data cause the user device to:
obtain initial motion data of the user device at the start of or just prior to the user commencing a gesture;
obtain ending motion data of the user device at the end of or just after the user ending the gesture; and
calculate, from the initial motion data and ending motion data, a deviation of a position of the user device at the end of the gesture from the start of the gesture.

20. The system according to claim 17, wherein the user device obtains the ML system from the remote server, and the ML system is an artificial neural network.
